(19) United States
(12) Patent Application Publication
(10) Pub. No.: US 2026/0113729 A1
(43) Pub. Date: Apr. 23, 2026

(54) DETECTING ANCHOR ACCESS POINT MISPLACEMENT IN WI-FI NETWORKS

(71) Applicant: Hewlett Packard Enterprise Development LP, Spring, TX (US)

(72) Inventors: Denis Houle, Sainte-Anne-De-Bellevue (CA); Vikram Raghu, Santa Clara, CA (US); Mathieu Mercier, Laval (CA)

(21) Appl. No.: 18/921,334

(22) Filed: Oct. 21, 2024

(51) Int. Cl. H04W 64/00; H04W 84/12

(52) U.S. Cl. CPC H04W 64/003; H04W 84/12

(57) ABSTRACT

In certain implementations, a system includes one or more processors, and one or more non-transitory computer-readable storage media storing programming for execution by the one or more processors, the programming including instructions to generate a proximity matrix containing distance measurements between access points (APs), where the APs include a plurality of anchor APs, generate from the proximity matrix an initial set of AP positions in a Cartesian coordinate system, generate a list of possible permutations of user-provided anchor AP coordinates for the plurality of anchor APs, compute a plurality of transformations, apply each transformation to the initial set of AP positions to generate a plurality of final sets of AP positions, calculate a distortion value for each final set of AP positions, and select a final set of AP positions from the plurality of final sets of AP positions based on the calculated distortion values.

### BACKGROUND

Wi-Fi networks have become ubiquitous in both residential and enterprise environments, providing wireless connectivity for a wide range of devices. In many Wi-Fi network deployments, particularly in large enterprises or public spaces, multiple access points (APs) are used to provide coverage over an extended area. Accurate knowledge of the physical locations of these APs is used for various network management tasks, including optimizing coverage, troubleshooting, and providing location-based services.

### BRIEF DESCRIPTION OF THE DRAWINGS

Aspects of the present disclosure are best understood from the following detailed description when read with the accompanying figures.

FIG. 1A illustrates an example system of a Wi-Fi Access Point (AP) management solution on which a process for detecting and correcting errors in anchor AP placement may be performed, according to some implementations.

FIG. 1B illustrates an example implementation of a computer system 150 that can utilize processes according to some implementations.

FIG. 2A illustrates an example process for detecting and correcting errors in anchor AP placement within a physical AP network, according to some implementations.

FIG. 2B illustrates an example proximity matrix that represents relative distances between pairs of AP in a physical AP network, according to some implementations.

FIGS. 2C, 2D, and 2E illustrate example geo-referenced floor plans that correspond to a physical floor, according to some implementations.

FIG. 3 illustrates an example method for detecting and correcting errors in anchor AP placement within a physical AP network, according to some implementations.

FIG. 4 illustrates an example method for detecting and correcting errors in anchor AP placement within a physical AP network, according to some implementations.

### DESCRIPTION

A solution for managing and locating Wi-Fi access points (APs) may be implemented as a cloud-based application, such as, for example, an enterprise application. The solution may operate on a system that includes several interconnected components, such as, for example, a cloud-based server infrastructure and a user interface (e.g., a web-based user interface) for users and/or network administrators. The solution may provide an automatic location feature that allows a user to determine and record the positions of APs on a geo-referenced floor plan (e.g., provided by the user) through the user interface. When the automatic location feature is initiated, the APs in a given area may perform Fine Timing Measurement (FTM) scans to measure distances between each AP and the other APs. In an implementation, the FTM scans can be performed either as a background task or as a dedicated scan. If the FTM scans are performed as a background task, the FTM scans can be taken continuously without disrupting normal network operations. Alternatively, a dedicated scan can be initiated when more immediate or focused measurements are needed. The solution then collects the results of the FTM scans and generates a proximity matrix of inter-AP distances (e.g., the distances between each AP and the other APs). The proximity matrix is uploaded to the cloud-based server infrastructure to be used subsequently as an input to compute the positions of the APs on the geo-referenced floor plan.

In addition to the proximity matrix, the positions of a set of anchor APs may be manually input on the geo-referenced floor plan by the user using an input device (e.g., a keyboard input or a mouse input). The anchor APs may include at least three APs selected by an algorithm that is running on the system, and these anchor APs are placed on the floor plan by the user as accurately as possible. The positions of the anchor APs serve as reference positions, and the combination of the proximity matrix and the positions of the anchor APs are used as inputs for the algorithm to generate a map of AP positions throughout the floor plan. However, the accuracy of this process relies on the correct placement of the anchor APs by the user, and errors in this step can lead to significant inaccuracies in the overall determination of AP positions on the floor plan.

Certain implementations of this disclosure provide techniques for accurately identifying and correcting errors in the manual placement of the anchor APs on the floor plan. These techniques may enhance the ability to detect potential anchor AP misplacements and suggest corrections, thereby improving the overall accuracy of the automatic location feature. For example, in a first step, an auto-locate module may utilize a Multi Dimensional Scaling (MDS) algorithm to generate an initial set of AP positions based on the previously generated proximity matrix. The proximity matrix contains the distances between all pairs of APs. The auto-locate module transforms these distances into a set of points in a Cartesian coordinate system, representing the relative positions of all APs, including the anchor APs. At this stage, the positions of the APs are in an arbitrary coordinate system, and not yet aligned with the actual floor plan.

In a second step, the auto-locate module may compute transformations to align the initial set of AP positions with the geo-referenced floor plan. This may include generating all possible permutations of the user-provided anchor AP positions, and for each permutation, computing a transformation that maps the initial set of AP positions to the floor plan coordinates. In this way, a plurality of transformations are computed. In a third step, each of the computed transformations of the plurality of transformations may then be applied to the initial set of AP positions to obtain a corresponding final set of AP positions. In this way, a plurality of final sets of AP positions is generated, where each final set of AP positions corresponds to a respective transformation of the plurality of transformations and a possible permutation of the user-provided anchor AP positions.

In a fourth step, the auto-locate module may calculate a distortion value for each final set of AP positions that corresponds to a possible permutation of the user-provided anchor AP positions. The distortion value may be a measure of how well the transformed positions of the final set of AP positions match the proximity matrix. This includes the distortion value for the transformed positions of the final set of AP positions that correspond to the actual user-provided anchor AP positions. To calculate the distortion value for each final set of AP positions, a difference between the distance between each pair of APs in the proximity matrix and the distance between the same pair of APs in the transformed positions of the final set of AP positions is calculated. An absolute value of the difference is then obtained. The absolute values of the differences of the pairs of the APs of the final set of AP positions are then summed to give the distortion value for the final set of AP positions. If the distortion value for the final set of AP positions that correspond to the actual user-provided anchor AP positions is not the smallest, the possible permutation of the user-provided anchor AP positions that has the smallest distortion value is selected as the most accurate positioning of the anchor APs, and this possible permutation of the user-provided anchor AP positions is compared to the actual user-provided anchor AP positions. An error notification may displayed on an output device (e.g., a display screen) to inform the user that an anchor AP placement error has been detected. In addition, a visual indicator may be used to indicate the misplaced anchor APs on the geo-referenced floor plan, as well as to suggest corrections for the correct placement of the misplaced anchor AP positions that corresponds to the smallest distortion value.

Certain implementations of this disclosure may provide one or more technical advantages. For example, certain implementations may allow a user and/or a network administrator to accurately determine and record the positions of APs on a user uploaded geo-referenced floor plan without the user having to manually indicate the physical position of every AP device on the floor plan. By using the automatic location feature, only the positions of a few anchor APs (e.g., four anchor APs) may need to be indicated by the user, and this may reduce the amount of time and effort needed to accurately map AP locations, especially in large-scale Wi-Fi network deployments. Additionally, the use of the automated location feature allows for an improved detection and correction of errors in anchor AP placement. The accurate AP positioning enabled by this solution allows for optimized network coverage, more efficient troubleshooting, and enhanced location-based services, including improved indoor navigation, asset tracking, and emergency response capabilities. Further, the reduction in user input errors and the need for frequent on-site verifications may result in lower operational costs for both service providers and enterprise clients.

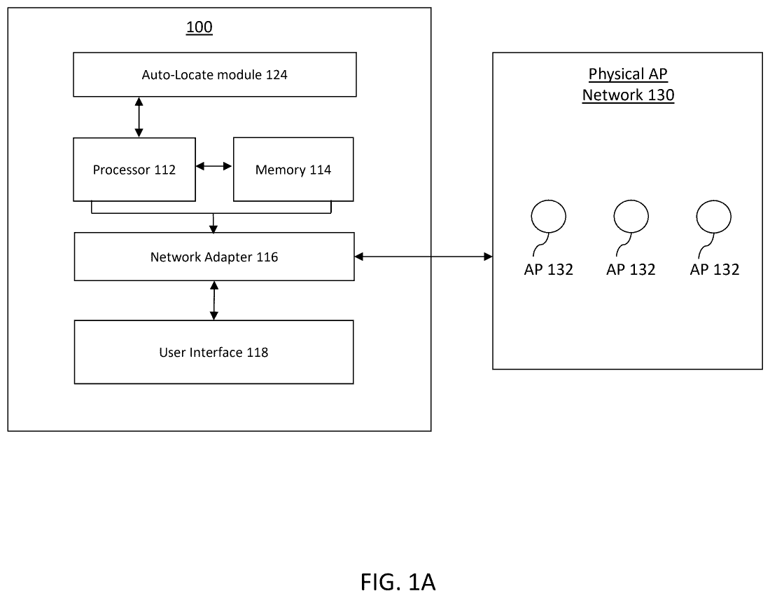

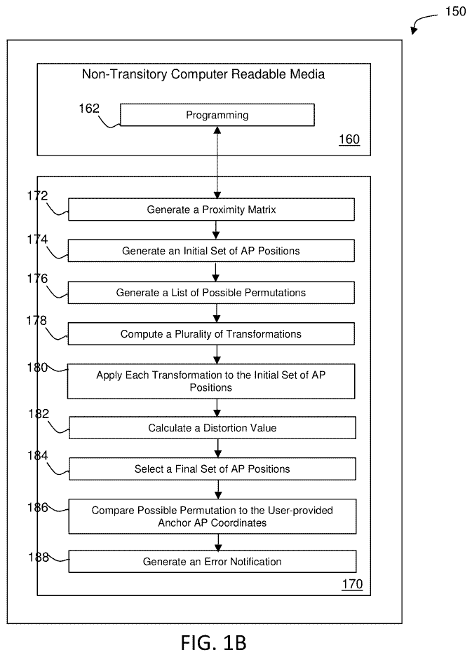

FIG. 1A illustrates an example system 100 of a Wi-Fi Access Point (AP) management solution that may operate in conjunction with a physical AP network 130. The physical AP network 130 may represent actual Wi-Fi APs 132 that are deployed in a client environment (e.g., throughout a floor or a level of a building). The solution may be implemented as a cloud-based application, such as for example, an enterprise application. The system 100 that hosts this application may be, for example, a cloud-based server, a dedicated hardware appliance, or a virtualized environment within an enterprise data center.

The system 100 may include a processor 112, which may perform a variety of operations such as executing various algorithms for AP positioning and anchor AP misplacement detection, processing data from the physical AP network 130, and managing interactions with a user Interface 118 (described below). The processor 112 may also process user inputs, such as for example, floor plan data and generate outputs, such as for example, results for visualization. The processor 112 may include one or more programmable logic devices, microprocessors, application-specific integrated circuits (ASICs), controllers, or any other suitable computing devices or resources or any combination of the preceding. In certain implementations, the processor 112 may be or may include a central processing unit (CPU).

In an implementation, the system 100 includes a memory 114, which may include a non-transitory computer readable medium that stores programming for execution by the processor 112. The memory 114 may provide fast, temporary storage for data and instructions that are actively used by the processor 112. This may include storing intermediate calculations during AP misplacement detection processes. The system 100 may include a network adapter 116 that may include an Ethernet adapter or other network interfaces. The network adapter 116 may facilitate communication between the system 100 and the physical AP network 130, enabling the transmission of proximity data from APs 132 of the physical AP network 130 and the delivery of configuration updates or commands to the APs 132 of the physical AP network 130. Users may interact with the system 100 through a user interface 118. The user interface 118 may be implemented for example, as a web-based user interface that allows access from various devices and locations. The user interface 118 may be able to incorporate various visual elements such as floor plan visualizations, AP location markers, input fields for anchor AP placement, and interactive elements for the system 100 configuration.

The system 100 may include an auto-locate module 124, which executes an automatic location feature of the Wi-Fi AP management solution. The automatic location feature may allow for the automated determination and verification of AP (e.g., the APs 132) positions within a client's environment (e.g., the physical AP network 130). The auto-locate module 124 may be implemented as a software component (e.g., running on the processor 112) that manages the collection of proximity data from the physical AP network 130, processes this data to determine AP 132 positions, and detects potential anchor AP misplacements. It may interact with other components of the system 100 to gather necessary data and execute auto-location algorithms.

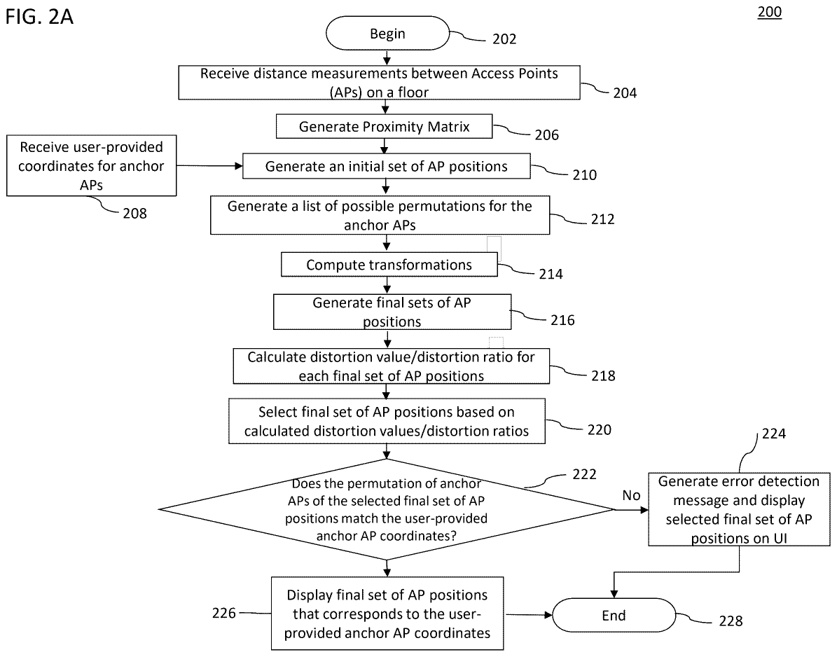

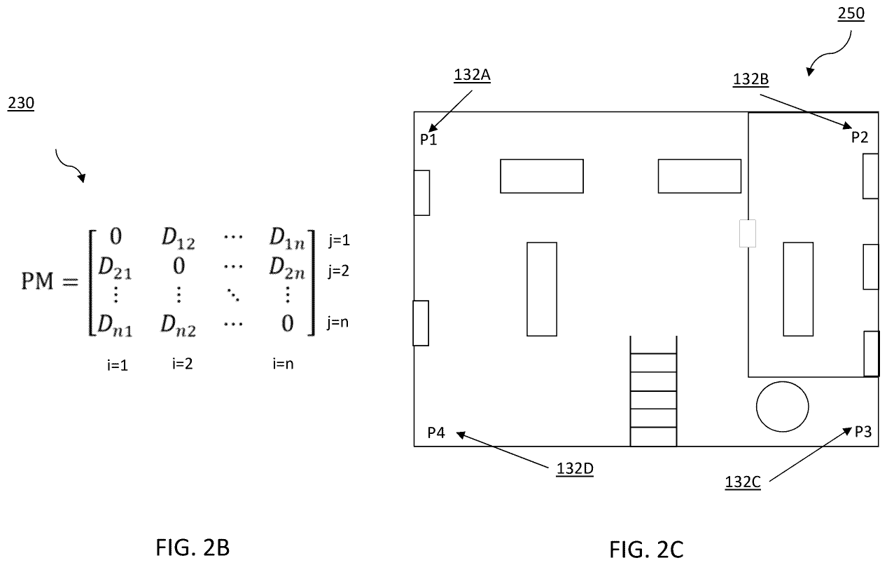

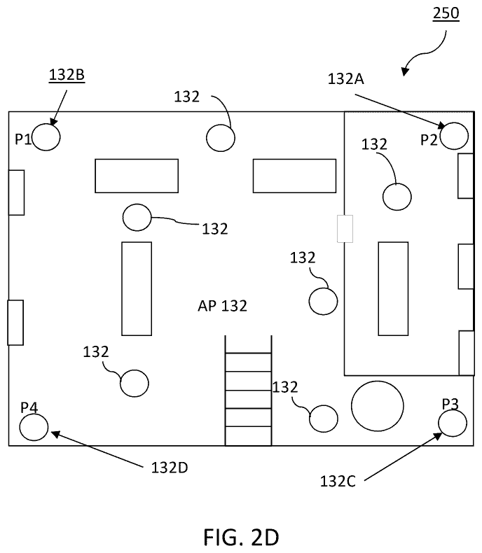

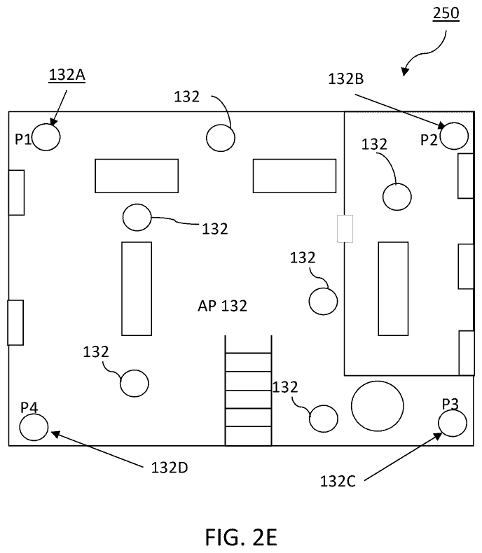

FIG. 1B depicts an example implementation of a computer system 150 that can utilize processes disclosed herein. The computer system is part of computer system 100 shown in FIG. 1A. For example, the system 150 may be a sub-system of the system 100. Further details of the process are provided in FIG. 2A.

As shown in FIG. 1B, the computer system 150 comprises one or more processors 170 and one or more non-transitory computer-readable storage media 160 storing programming 162 for execution by the one or more processors 170. The programming comprises instructions 172-188 to generate a proximity matrix containing distance measurements between access points (APs) on a floor, where the APs include a plurality of anchor APs (172). An initial set of AP positions is generated in a Cartesian coordinate system from the proximity matrix and user-provided coordinates for the plurality of anchor APs (174). A list of possible permutations of the user-provided anchor AP coordinates is generated (176). A plurality of transformations is computed, where each transformation corresponds to a possible permutation in the list of possible permutations (178). Each transformation of the plurality of transformations is applied to the initial set of AP positions to generate a plurality of final sets of AP positions (180). A distortion value for each final set of AP positions relative to the proximity matrix is calculated (182). A final set of AP positions is selected from the plurality of final sets of AP positions based on the calculated distortion values (184). The possible permutation corresponding to the selected final set of AP positions is compared with the user-provided anchor AP coordinates (186). An error notification is generated based on whether the comparison of the possible permutation corresponding to the selected final set of AP positions with the user-provided anchor AP coordinates indicates two or more misplaced anchor APs (188).

FIG. 2A illustrates a flowchart 200 of a process for detecting and correcting errors in anchor AP (e.g., anchor AP 132A, 132B, 132C, and 132D described below) placement within a client environment (e.g., the physical AP network 130). The APs 132 of the physical AP network 130 may be installed or deployed by a client in their physical environment, such as a physical floor, office building, warehouse, campus, or other facility, to provide Wi-Fi coverage within the physical environment. The anchor AP placement error detection and correction process depicted in FIG. 2A may be performed using the components and architecture described in FIGS. 1A-1B, although other architectures could also utilize the process. The anchor AP placement error detection and correction process may be initiated using, for example, an automated location feature that is provided by the Wi-Fi AP management solution. Once the automated location feature is activated (e.g., such as by activating an interactive button, or using an input such as a mouse input, or a keyboard input), the automated location feature may aim to simplify and streamline the process of determining AP locations, as well as detecting and correcting potential anchor AP misplacements.

Step 202 marks the beginning of the anchor AP placement error detection and correction process for installed APs 132 (e.g., on a physical floor) of the physical AP network 130. This process may be initiated as part of the automated location feature provided by the Wi-Fi AP management solution. The automated location feature can be activated by a user by various means, such as by interacting with the user interface 118 (described previously in FIGS. 1A-1B) by for example, clicking an interactive button, or using other input methods like a mouse click or keyboard command.

In step 204, the auto-locate module 124 may receive distance measurements between actual APs 132 of the physical AP network 130 in the client environment (e.g., on the physical floor). The physical AP network 130 can include any number of APs 132. The distance measurements may be obtained through Fine Timing Measurement (FTM) scans performed by the APs 132 in the physical AP network 130. FTM is a Wi-Fi technology that allows for precise distance measurements between devices. Each AP 132 in the physical AP network 130 may perform FTM scans to measure its distance from other APs 132, creating a web of inter-AP distances across the entire physical floor. In an implementation, the FTM scans may be performed at regular intervals as a background task to provide ongoing, up-to-date distance information without disrupting normal network operations. In other implementations, the FTM scans may be performed when the automated location feature is initiated (e.g., as described previously in the step 202).

In Step 206, a proximity matrix 230 (e.g., shown subsequently in FIG. 2B) is generated by the auto-locate module 124 based on the received distance measurements from the previous step 204. The proximity matrix 230 may be a data structure that represents the relative distances between all pairs of APs 132 in the physical AP network 130. As illustrated in FIG. 2B, the proximity matrix 230 is an n×n square matrix, where n is the total number of APs 132 in the physical AP network 130, and both rows and columns represent the APs 132. Each cell (i, j) in the proximity matrix 230 contains the measured distance between AP i and AP j. The diagonal elements of the proximity matrix 230 (where i=j) are typically zero, representing the distance of an AP 132 to itself. The auto-locate module 124 may use the proximity matrix 230 as an input for subsequent calculations in the anchor AP placement error detection and correction process.

In step 208, the auto-locate module 124 may receive user-provided coordinates for anchor APs on a geo-referenced floor plan (e.g., the geo-referenced floor plan 250 shown in FIG. 2C) of the physical floor. The geo-referenced floor plan 250 may be inputted into the system 100 by the user (e.g., by using the user interface 118) prior to or during the step 208. For example, in an implementation, the user may input the geo-referenced floor plan 250 during the anchor AP placement error detection and correction process, or the user may input the geo-referenced floor plan 250 before the anchor AP placement error detection and correction process is initiated. In the step 208, the auto-locate module 124 may employ an algorithm to select at least three APs of the APs 132 to serve as anchor APs. In an implementation, the auto-locate module 124 may employ the algorithm to select four APs (e.g., the anchor AP 132A, the anchor AP 132B, the anchor AP 132C, and the anchor AP 132D) of the APs 132 to serve as anchors APs. The anchor APs 132A-D may be selected strategically by the auto-locate module 124 to be used as reference positions for determining the locations of other APs 132 in the physical AP network 130. These reference positions may be selected to be easily identifiable points within the environment, such as corners of the geo-referenced floor plan 250. The system 100 may then prompt the user to manually input the positions of the anchor APs (132A-132D) on the geo-referenced floor plan 250 through the user interface 118.

The positions of the anchor APs 132A-D may be manually input into the geo-referenced floor plan 250 by the user (e.g., by using an input device such as a keyboard input or a mouse input). For example, as shown in FIG. 2C, the user may manually place the anchor AP 132A at point P1, the anchor AP 132B at point P2, the anchor AP 132C at point P3, and the anchor AP 132D at point P4 on the geo-referenced floor plan 250. The positions of the anchor APs 132A-D (e.g., represented by the term UserAnchorPos) may be expressed using the following equation (1):

$$UserAnchorPos = \{ {P}_{a} ( {x}_{a} , {y}_{a} ) , {P}_{b} ( {x}_{b} , {y}_{b} ) , {P}_{c} ( {x}_{c} , {y}_{c} ) , {P}_{d} ( {x}_{d} , {y}_{d} ) \} \qquad ( 1 )$$

where Pₐ(xₐ,yₐ) represents the position of the anchor AP 132A at the point P1, where xₐ and yₐ are its x and y coordinates respectively on the geo-referenced floor plan 250, P_{b}(x_{b}, y_{b}) represents the position of the anchor AP 132B at the point P2, where x_{b} and y_{b} are its x and y coordinates respectively on the geo-referenced floor plan 250, P_{c}(x_{c}, y_{c}) represents the position of the anchor AP 132C at the point P3, where x_{c} and y_{c} are its x and y coordinates respectively on the geo-referenced floor plan 250, and P_{d}(x_{d},y_{d}) represents the position of the anchor AP 132D at the point P4, where x_{d} and yₐ are its x and y coordinates respectively on the geo-referenced floor plan 250.

In step 210, the auto-locate module 124 generates an initial set of AP positions for the APs 132 based on the proximity matrix 230. For example, the auto-locate module 124 may utilize a Multi-Dimensional Scaling (MDS) algorithm to create a relative positioning of all APs 132 (including the anchor APs 132A-D) in a Cartesian coordinate system. The proximity matrix 230 contains the distances between all pairs of the APs 132. The MDS algorithm may use the proximity matrix 230 as an input, and transform these distances into a set of points in the Cartesian coordinate system, representing the relative positions of all APs 132, including the anchor APs 132A-D. At this stage, the positions of the APs 132 are in an arbitrary coordinate system, and not yet aligned with the actual geo-referenced floor plan 250.

The initial set of AP positions (e.g., represented by the term POSᵢₙᵢₜᵢₐₗ) for the APs 132 may be expressed using the following equation (2):

$${POS}_{initial} = MDS ( PM ) \to \{ {P}_{1} ( {x}_{1} , {y}_{1} ) , {P}_{2} ( {x}_{2} , {y}_{2} ) , … , {P}_{n} ( {x}_{n} , {y}_{n} ) \} \qquad ( 2 )$$

where P₁(x₁, y₁) is the position of a first AP 132 of the APs 132, where x₁ and y₁ are the x and y coordinates of the first AP132, respectively, P₂(x₂,y₂) is the position of a second AP 132 of the APs 132, where x₂ and y₂ are the x and y coordinates of the second AP 132, respectively, and Pₙ(xₙ,yₙ) represents the position of the nth AP 132 of the APs 132, where xₙ and yₙ are the x and y coordinates of the nth AP132, respectively, where n is the total number of APs 132 in the physical AP network 130.

In step 212, the auto-locate module 124 may generate a list of all possible permutations for the user-provided anchor AP positions. If in an implementation, four anchor APs 132A-D are utilized, this would result in 24 (e.g., 4!) different permutations. Each possible permutation may represent a different way of mapping the user-provided anchor AP coordinates to the actual anchor APs (e.g., the anchor APs 132A-D) selected by the auto-locate module 124 in the step 208.

In step 214, for each possible permutation of the user-provided anchor AP positions, the auto-locate module 124 may compute a transformation that maps the initial set of AP positions (from the step 210) to the geo-referenced floor plan 250 coordinates. In this way, a plurality of transformations are computed. Each transformation of the plurality of transformations may include translation, rotation, and/or scaling to align the initial set of AP positions to the geo-referenced floor plan 250. The plurality of transformations (e.g., represented by the term Tₗᵢₛₜ) may be expressed using the following equation (3):

$${T}_{list} = ComputeTransform ( {POS}_{initial} , AnchorPermutationList ) \qquad ( 3 )$$

where Compute Transform is a function that calculates the transformation needed to align the initial set of AP positions with each possible permutation (also referred to as arrangement) of anchor AP positions, POSᵢₙᵢₜᵢₐₗ is the initial set of AP positions for the APs 132 generated previously in the previous step 210, and AnchorPermutationList is the list of all possible permutations of the user-provided anchor AP positions that was generated previously in the step 212.

In step 216, the auto-locate module 124 applies each of the computed transformations of the plurality of transformations to the initial set of AP positions to obtain a corresponding final set of AP positions. In this way, a plurality of final sets of AP positions is generated, where each final set of AP positions corresponds to a respective transformation of the plurality of transformations and a possible permutation of the user-provided anchor AP (e.g., the anchor APs 132A-D) positions. The plurality of final sets of AP positions (e.g., represented by the term POSₗᵢₛₜ) may be expressed using the following equation (4):

$${POS}_{list} = ApplyTransform ( {T}_{list} , {POS}_{initial} ) \qquad ( 4 )$$

where ApplyTransform is a function that applies each transformation of the plurality of transformations (Tₗᵢₛₜ) computed previously in the step 214 to the initial set of AP positions (POSᵢₙᵢₜᵢₐₗ) generated previously in the step 210.

In step 218, the auto-locate module 124 may calculate a distortion value for each final set of AP positions that corresponds to a possible permutation of the user-provided anchor AP positions. The distortion value may be a measure of how well the transformed positions of the final set of AP positions match the proximity matrix 230. This includes the distortion value for the transformed positions of the final set of AP positions that correspond to the actual user-provided anchor AP positions. To calculate the distortion value for each final set of AP positions, a difference between the distance between each distinct pair of APs (e.g., distinct pairs of the APs 132) in the proximity matrix 230 and the distance between the same distinct pair of APs in the transformed positions of the final set of AP positions is calculated. An absolute value of the difference is then obtained. The absolute values of the differences of the distinct pairs of the APs of the final set of AP positions are then summed to give the distortion value for the final set of AP positions.

In an implementation, after the distortion values for the plurality of final sets of AP positions (e.g., POSₗᵢₛₜ) that correspond to all possible permutations of the user-provided anchor AP positions are calculated, the auto-locate module 124 may compare these distortion values to each other to determine the smallest distortion value, and the auto-locate module additionally determines the corresponding final set of AP positions of the plurality of final sets of AP positions (e.g., POSₗᵢₛₜ) that is associated with the smallest distortion value. The smallest distortion value may be represented by the following expression (5):

$$Smallest Distortion Value = min ( Distortion ( {POS}_{initial} , {POS}_{list} [ j ] ) ) \qquad ( 5 )$$

where min( ) is a function that returns the minimum value from a set of values, Distortion( ) is a function that calculates the distortion between two sets of AP positions, POSᵢₙᵢₜᵢₐₗ represents the initial set of AP positions generated previously in the step 210, POS_{list[j]} represents the jth set of the plurality of final sets of AP positions that correspond to all possible permutations, and j is an index that iterates through all the possible permutations in the plurality of final sets of AP positions (POSₗᵢₛₜ).

In an implementation, the auto-locate module 124 may further calculate a distortion ratio for each final set of AP positions of the plurality of final sets of AP positions (e.g., POSₗᵢₛₜ). The distortion ratio for each final set of AP positions is calculated by dividing the distortion value of the final set of AP positions by the smallest distortion value (described above). The distortion ratio may be expressed using the following equation (6):

$${DistortionRatio}_{j} = \frac{Distortion ( {POS}_{initial} , {POS}_{j} )}{min ( Distortion ( {POS}_{initial} , {POS}_{list} [ j ] ) )} \qquad ( 6 )$$

where DistortionRatioⱼ is the distortion ratio for the jth final set of AP positions of the plurality of final sets of AP positions (e.g., POSₗᵢₛₜ), Distortion(POSᵢₙᵢₜᵢₐₗ, POSⱼ) is the distortion value for the jth final set of AP positions, and min(Distortion(POSᵢₙᵢₜᵢₐₗ, POSₗᵢₛₜ[j])) is the smallest distortion value (described above) among all the distortion values of the plurality of final sets of AP positions (e.g., POSₗᵢₛₜ).

In step 220, the auto-locate module 124 may in an implementation, select a final set of AP positions from the plurality of final sets of AP positions (e.g., POSₗᵢₛₜ) based on the calculated distortion values from the step 218. The auto-locate module 124 may select the final set of AP positions that corresponds to the smallest distortion value as the correct configuration of AP positions of the physical AP network 130.

In other implementations, during the step 220, the auto-locate module 124 may selectively filter out candidate final sets of AP positions from the plurality of final sets of AP positions (e.g., POSₗᵢₛₜ) based on the calculated distortion ratios from the step 218. For example, the auto-locate module 124 may determine if the calculated distortion ratio for each final set of AP positions is equal to or exceeds a threshold value. The final sets of AP positions of the plurality of final sets of AP positions (e.g., POSₗᵢₛₜ) that have calculated distortion ratios that are not equal to or do not exceed the threshold value may be deemed as candidates having possibly correct configurations of AP positions of the physical AP network 130. The final sets of AP positions of the plurality of final sets of AP positions (e.g., POSₗᵢₛₜ) that have calculated distortion ratios that are equal to or exceed the threshold value may be deemed as having incorrect configurations of AP positions of the physical AP network 130. In an implementation, the threshold value may be between 13 and 17, e.g., equal to 15. In an implementation, the threshold value may be selected as any suitable number.

In step 222, the auto-locate module 124 may in an implementation, compare the permutation of anchor APs of the selected final set of AP positions (described in the step 220 above) with the user-provided anchor AP coordinates. For example, the auto-locate module 124 may determine whether the arrangement of anchor APs (e.g., the anchor APs 132A-D) in the selected final set of AP positions (which was determined to have the smallest distortion value) matches the arrangement of the anchor APs (e.g., the anchor APs 132A-D) provided by the user in the step 208.

In an implementation, if it is determined during the step 222 that the permutation of anchor APs of the selected final set of AP positions does not match the user-provided anchor AP coordinates, an error detection message may be generated and displayed on the user interface 118 (e.g., using a display component, such as for example, a display screen) as shown in step 224 of the flowchart 200. The error detection message may, for example, notify the user that a potential misplacement of anchor APs (e.g., two or more of the APs 132A-D) has been detected. In addition, the error detection message may include suggested corrections for the anchor AP placements based on the selected final set of AP positions. Further, the selected final set of AP positions may be displayed on the geo-referenced floor plan 250 using the user interface 118 as shown in the FIG. 2D, which provides a visual representation of the suggested correct AP (e.g., the APs 132) positioning on the physical floor. If it is determined during the step 222 that the permutation of anchor APs of the selected final set of AP positions matches the user-provided anchor AP coordinates, the final set of AP positions that corresponds to the user-provided anchor AP coordinates may be displayed on the user interface 118 (e.g., using a display component, such as for example, a display screen) as shown in step 226 of the flowchart 200. This display may include showing the positions of all APs 132 on the geo-referenced floor plan 250 as shown in the FIG. 2E. After the step 224 or the step 226 is performed, the anchor AP placement error detection and correction process is terminated, as marked by the step 228 of the flowchart 200.

In other implementations, during the step 222, the auto-locate module 124 may compare the permutations of anchor APs of the candidate final sets of AP positions (described in the step 220 above) with the user-provided anchor AP coordinates.

In an implementation, if it is determined during the step 222 that every permutation of anchor APs of the candidate final sets of AP positions does not match the user-provided anchor AP coordinates, an error detection message may be generated and displayed on the user interface 118 (e.g., using a display component, such as for example, a display screen) as shown in the step 224 of the flowchart 200. The error detection message may, for example, notify the user that a potential misplacement of anchor APs (e.g., two or more of the APs 132A-D) has been detected. In addition, the error detection message may include suggested corrections for the anchor AP placements based on the candidate final set of AP positions. For example, the candidate final set of AP positions that is associated with the smallest distortion value may be selected as the correct configuration of AP positions of the physical AP network 130. This candidate final set of AP positions may then be displayed on the geo-referenced floor plan 250 using the user interface 118 as shown in the FIG. 2D, in order to provide a visual representation of the suggested correct AP (e.g., the APs 132) positioning on the physical floor. In an implementation, If it is determined during the step 222 that a permutation of anchor APs of a candidate final set of AP positions does match the user-provided anchor AP coordinates, the final set of AP positions that corresponds to the user-provided anchor AP coordinates may be displayed on the user interface 118 (e.g., using a display component, such as for example, a display screen) as shown in the step 226 of the flowchart 200. This display may include showing the positions of all APs 132 on the geo-referenced floor plan 250 as shown in the FIG. 2E. After the step 224 or the step 226 is performed, the anchor AP placement error detection and correction process is terminated, as marked by the step 228 of the flowchart 200.

In other implementations, in addition to the distortion value and the distortion ratio that were described above, other metrics and algorithms may be also employed to further enhance the performance of the anchor AP placement error detection and correction process. For example, the system may consider the total number of APs 132 in the physical AP network 130, as a higher number of APs 132 would provide more data points for triangulation, and this may potentially improve AP placement error detection accuracy. The mean error of anchor APs could also be calculated as the average discrepancy between user-provided AP positions and estimated positions based on proximity data. This metric may help gauge and improve the overall reliability of the anchor AP placements.

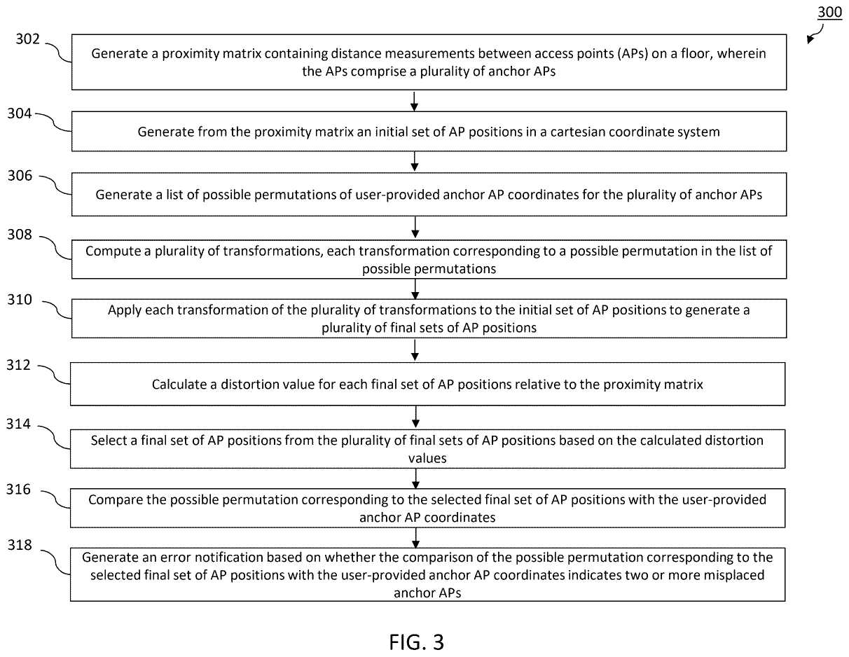

FIG. 3 illustrates an example method 300 for detecting and correcting errors in anchor AP (e.g., anchor APs 132A-D described previously in FIGS. 1A-2E) placement within a physical AP network (e.g., the physical AP network 130 described previously in FIGS. 1A-2E). The anchor AP placement error detection and correction process may be initiated using, for example, the automated location feature (described previously in FIGS. 1A-2E) that is provided by the Wi-Fi AP management solution. The automated location feature may be activated by various means, such as for example, activating an interactive button, or using an input such as a mouse input, or a keyboard input.

In step 302, a proximity matrix containing distance measurements between access points (APs) on a floor is generated, where the APs include a plurality of anchor APs. For example, the proximity matrix 230 (e.g., shown in FIG. 2B) may be generated as described in the step 206 of the flowchart 200 by the auto-locate module 124 (described previously in FIGS. 1A-2E) based on the received distance measurements from the previous step 204 of the flowchart 200.

In step 304, an initial set of AP positions is generated in a Cartesian coordinate system from the proximity matrix. For example, the auto-locate module 124 may utilize a Multi-Dimensional Scaling (MDS) algorithm to create a relative positioning of all APs 132 (including the anchor APs 132A-D) in a Cartesian coordinate system as described previously in the step 210 of the flowchart 200.

In step 306, a list of possible permutations of user-provided anchor AP coordinates for the plurality of anchor APs is generated. For example, the auto-locate module 124 may generate a list of all possible permutations for user-provided anchor AP positions as described in the step 212 of the flowchart 200, where each possible permutation represents a different way of mapping the user-provided anchor AP coordinates to the actual anchor APs (e.g., the anchor APs 132A-D) selected by the auto-locate module 124 in the step 208 of the flowchart 200.

In step 308, a plurality of transformations is computed, where each transformation corresponds to a possible permutation in the list of possible permutations. For example, for each possible permutation of the user-provided anchor AP positions, the auto-locate module 124 may compute a transformation that maps the initial set of AP positions (from the step 210 of the flowchart 200) to the geo-referenced floor plan 250 coordinates as described previously in the step 214 of the flowchart 200.

In step 310, each transformation of the plurality of transformations is applied to the initial set of AP positions to generate a plurality of final sets of AP positions. For example, as described in the step 216 of the flowchart 200, the auto-locate module 124 may apply each of the computed transformations (from the step 214 of the flowchart 200) of the plurality of transformations to the initial set of AP positions to obtain a corresponding final set of AP positions. In this way, a plurality of final sets of AP positions is generated, where each final set of AP positions corresponds to a respective transformation of the plurality of transformations and a possible permutation of the user-provided anchor AP (e.g., the anchor APs 132A-D) positions.

In step 312, a distortion value is calculated for each final set of AP positions relative to the proximity matrix. For example, the auto-locate module 124 may calculate a distortion value for each final set of AP positions that corresponds to a possible permutation of the user-provided anchor AP positions as described previously in the step 218 of the flowchart 200.

In step 314, a final set of AP positions from the plurality of final sets of AP positions is selected based on the calculated distortion values. For example, as described previously in the step 220 of the flowchart 200, the auto-locate module 124 may select a final set of AP positions from the plurality of final sets of AP positions based on the calculated distortion values from the step 218 of the flowchart 200. The auto-locate module 124 may select the final set of AP positions that corresponds to the smallest distortion value as the correct configuration of AP positions of the physical AP network 130.

In step 316, the possible permutation corresponding to the selected final set of AP positions is compared with the user-provided anchor AP coordinates. For example, as described in the step 222 of the flowchart 200, the auto-locate module 124 may compare the permutation of anchor APs of the selected final set of AP positions (from the step 220 of the flowchart 200) with the user-provided anchor AP coordinates to determine whether the arrangement of anchor APs (e.g., the anchor APs 132A-D) in the selected final set of AP positions matches the arrangement of the anchor APs (e.g., the anchor APs 132A-D) provided by the user in the step 208 of the flowchart 200.

In step 318, an error notification is generated based on whether the comparison of the possible permutation corresponding to the selected final set of AP positions with the user-provided anchor AP coordinates indicates two or more misplaced anchor APs. For example, if it is determined during the step 222 of the flowchart 200 that the permutation of anchor APs of the selected final set of AP positions does not match the user-provided anchor AP coordinates, an error detection message may be generated and displayed on the user interface 118 (e.g., using a display component, such as for example, a display screen) as shown in the step 224 of the flowchart 200. The error detection message may, for example, notify the user that a potential misplacement of anchor APs (e.g., two or more of the APs 132A-D) has been detected. In addition, the error detection message may include suggested corrections for the anchor AP placements based on the selected final set of AP positions.

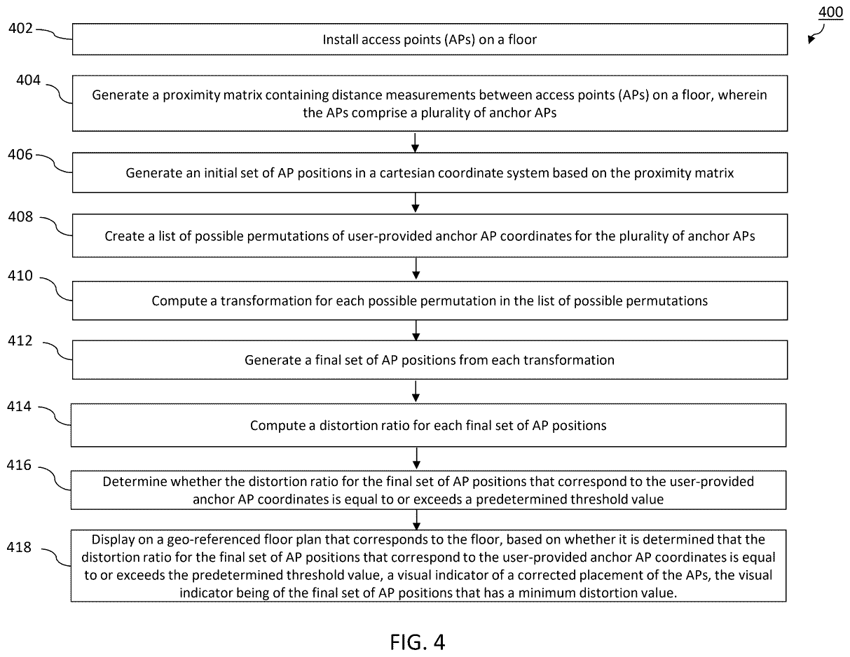

FIG. 4 illustrates an example method 400 for detecting and correcting errors in anchor AP (e.g., anchor APs 132A-D described previously in FIGS. 1A-2E) placement within a physical AP network (e.g., the physical AP network 130 described previously in FIGS. 1A-2E).

In step 402, access points (APs) are installed on a floor. For example, as described previously in FIG. 2A, The APs 132 of the physical AP network 130 may be installed or deployed in a physical environment, such as for example, a physical floor, office building, warehouse, campus, or other facility, to provide Wi-Fi coverage within the physical environment.

In step 404, a proximity matrix containing distance measurements between access points (APs) on a floor is generated, wherein the APs comprise a plurality of anchor APs. For example, the proximity matrix 230 (e.g., shown in FIG. 2B) may be generated as described in the step 206 of the flowchart 200 by the auto-locate module 124 (described previously in FIGS. 1A-2E) based on the received distance measurements from the previous step 204 of the flowchart 200.

In step 406, an initial set of AP positions is generated in a Cartesian coordinate system based on the proximity matrix. For example, the auto-locate module 124 may utilize a Multi-Dimensional Scaling (MDS) algorithm to create a relative positioning of all APs 132 (including the anchor APs 132A-D) in a Cartesian coordinate system as described previously in the step 210 of the flowchart 200.

In step 408, a list of possible permutations of user-provided anchor AP coordinates for the plurality of anchor APs is created. For example, the auto-locate module 124 may generate a list of all possible permutations for the user-provided anchor AP positions as described in the step 212 of the flowchart 200, where each possible permutation represents a different way of mapping the user-provided anchor AP coordinates to the actual anchor APs (e.g., the anchor APs 132A-D) selected by the auto-locate module 124 in the step 208 of the flowchart 200.

In step 410, a transformation is computed for each possible permutation in the list of possible permutations. For example, for each possible permutation of the user-provided anchor AP positions, the auto-locate module 124 may compute a transformation that maps the initial set of AP positions (from the step 210 of the flowchart 200) to the geo-referenced floor plan 250 coordinates as described previously in the step 214 of the flowchart 200.

In step 412, a final set of AP positions is generated from each transformation. For example, as described in the step 216 of the flowchart 200, the auto-locate module 124 may apply each of the computed transformations (from the step 214 of the flowchart 200) of the plurality of transformations to the initial set of AP positions to obtain a corresponding final set of AP positions. In this way, a plurality of final sets of AP positions is generated, where each final set of AP positions corresponds to a respective transformation of the plurality of transformations and a possible permutation of the user-provided anchor AP (e.g., the anchor APs 132A-D) positions.

In step 414, a distortion ratio is computed for each final set of AP positions. For example, as described previously in the step 218 of the flowchart 200, the auto-locate module 124 may calculate a distortion ratio for each final set of AP positions of the plurality of final sets of AP positions by dividing the distortion value of the final set of AP positions by the smallest distortion value of the distortion values of the plurality of final sets of AP positions.

In step 416, it is determined whether the distortion ratio for the final set of AP positions that correspond to the user-provided anchor AP coordinates is equal to or exceeds a predetermined threshold value. For example, as described previously in the step 220 of the flowchart 200, the auto-locate module 124 may determine if the calculated distortion ratio for each final set of AP positions is equal to or exceeds a threshold value. The final sets of AP positions of the plurality of final sets of AP positions that have calculated distortion ratios that are not equal to or do not exceed the threshold value may be deemed as candidates having possibly correct configurations of AP positions of the physical AP network 130. The final sets of AP positions of the plurality of final sets of AP positions that have calculated distortion ratios that are equal to or exceed the threshold value may be deemed as having incorrect configurations of AP positions of the physical AP network 130. Subsequently, as described in the step 222 of the flowchart 200, the auto-locate module 124 may compare the permutations of anchor APs of the candidate final sets of AP positions (obtained in the step 220) with the user-provided anchor AP coordinates to determine if the final set of AP positions that correspond to the user-provided anchor AP coordinates is among the candidate final sets of AP positions.

In step 418, a visual indicator of a corrected placement of the APs is displayed on a geo-referenced floor plan that corresponds to the floor based on whether it is determined that the distortion ratio for the final set of AP positions that correspond to the user-provided anchor AP coordinates is equal to or exceeds the predetermined threshold value, the visual indicator being of the final set of AP positions that has a minimum distortion value. For example, if it is determined during the step 222 of the flowchart 200 that every permutation of anchor APs of the candidate final sets of AP positions does not match the user-provided anchor AP coordinates, an error detection message may be generated and displayed on the user interface 118 (e.g., using a display component, such as for example, a display screen) as shown in the step 224 of the flowchart 200. The error detection message may, for example, notify the user that a potential misplacement of anchor APs (e.g., two or more of the APs 132A-D) has been detected. In addition, the error detection message may include suggested corrections for the anchor AP placements based on the candidate final set of AP positions. For example, the candidate final set of AP positions that is associated with the smallest distortion value may be selected as the correct configuration of AP positions of the physical AP network 130. This candidate final set of AP positions may then be displayed on the geo-referenced floor plan 250 using the user interface 118 as shown in the FIG. 2D, in order to provide a visual representation of the suggested correct AP (e.g., the APs 132) positioning on the physical floor.

It should be understood that the systems and methods described in this disclosure may be combined in any suitable manner.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

The foregoing outlines features of several examples so that those skilled in the art may better understand the aspects of the present disclosure. Various modifications and combinations of the illustrative examples, as well as other examples, will be apparent to persons skilled in the art upon reference to the description. It is therefore intended that the appended claims encompass any such modifications.

What is claimed is:

1. A system, comprising:
one or more processors; and
one or more non-transitory computer-readable storage media storing programming for execution by the one or more processors, the programming comprising instructions to:
generate a proximity matrix containing distance measurements between access points (APs) on a floor, wherein the APs comprise a plurality of anchor APs;
generate, from the proximity matrix an initial set of AP positions in a Cartesian coordinate system;
generate a list of possible permutations of user-provided anchor AP coordinates for the plurality of anchor APs;
compute a plurality of transformations, each transformation corresponding to a possible permutation in the list of possible permutations;
apply each transformation of the plurality of transformations to the initial set of AP positions to generate a plurality of final sets of AP positions;
calculate a distortion value for each final set of AP positions relative to the proximity matrix;
select a final set of AP positions from the plurality of final sets of AP positions based on the calculated distortion values;
compare the possible permutation corresponding to the selected final set of AP positions with the user-provided anchor AP coordinates; and
generate an error notification based on whether the comparison of the possible permutation corresponding to the selected final set of AP positions with the user-provided anchor AP coordinates indicates two or more misplaced anchor APs.

2. The system of claim 1, wherein the programming comprises further instructions to:
display on a geo-referenced floor plan, a visual indicator of the two or more misplaced anchor APs and recommended corrections for placement of the two or more misplaced anchor APs based on the possible permutation corresponding to the selected final set of AP positions.

3. The system of claim 1, wherein calculating the distortion value for each final set of AP positions comprises:
calculating a difference between the distance between each distinct pair of APs in the proximity matrix and the distance between the same distinct pair of APs in the transformed positions of the final set of AP positions;
obtaining an absolute value of the difference; and
summing the absolute values of the differences of the distinct pairs of the APs of the final set of AP positions.

4. The system of claim 1, wherein the plurality of anchor APs comprises at least three anchor APs.

5. The system of claim 1, wherein selecting the final set of AP positions from the plurality of final sets of AP positions based on the calculated distortion values comprises identifying the final set of AP positions that has the smallest distortion value.

6. The system of claim 5, wherein the programming comprises further instructions to:
calculate a distortion ratio for each final set of AP positions by dividing the calculated distortion value for the final set of AP positions by the smallest distortion value.

7. A computer-implemented method, comprising:
generating, by a computer system, a proximity matrix containing distance measurements between access points (APs) on a floor, wherein the APs comprise a plurality of anchor APs;
generating from the proximity matrix, by the computer system, an initial set of AP positions in a Cartesian coordinate system;
generating, by the computer system, a list of possible permutations of user-provided anchor AP coordinates for the plurality of anchor APs;
computing, by the computer system, a plurality of transformations, each transformation corresponding to a possible permutation in the list of possible permutations;
applying, by the computer system, each transformation of the plurality of transformations to the initial set of AP positions to generate a plurality of final sets of AP positions;
calculating, by the computer system, a distortion value for each final set of AP positions relative to the proximity matrix;
selecting, by the computer system, a final set of AP positions from the plurality of final sets of AP positions based on the calculated distortion values;
comparing the possible permutation corresponding to the selected final set of AP positions with the user-provided anchor AP coordinates; and
generating an error notification based on whether the comparison of the possible permutation corresponding to the selected final set of AP positions with the user-provided anchor AP coordinates indicates two or more misplaced anchor APs.

8. The computer-implemented method of claim 7, further comprising:
obtaining, by the computer system, the user-provided coordinates for the plurality of anchor APs on a geo-referenced floor plan that corresponds to the floor.

9. The computer-implemented method of claim 8, further comprising:
displaying on the geo-referenced floor plan, a visual indicator of the two or more misplaced anchor APs and recommended corrections for placement of the two or more misplaced anchor APs based on the possible permutation corresponding to the selected final set of AP positions.

10. The computer-implemented method of claim 7, wherein generating the proximity matrix comprises:
receiving distance measurements between each AP on the floor and other APs on the floor; and
generating a matrix that represents the distance measurements.

11. The computer-implemented method of claim 10, wherein receiving distance measurements between each AP on the floor and other APs on the floor comprises performing Fine Timing Measurement (FTM) scans to measure distances between each AP and other APs on the floor.

12. The computer-implemented method of claim 7, wherein the plurality of anchor APs comprises at least three anchor APs.

13. The computer-implemented method of claim 7, wherein calculating the distortion value for each final set of AP positions comprises:
calculating a difference between the distance between each distinct pair of APs in the proximity matrix and the distance between the same distinct pair of APs in the transformed positions of the final set of AP positions;
obtaining an absolute value of the difference; and
summing the absolute values of the differences of the distinct pairs of the APs of the final set of AP positions.

14. The computer-implemented method of claim 7, wherein selecting the final set of AP positions from the plurality of final sets of AP positions based on the calculated distortion values comprises identifying the final set of AP positions that has the smallest distortion value.

15. A method comprising:
installing access points (APs) on a floor;
generating a proximity matrix containing distance measurements between the APs on the floor, wherein the APs comprise a plurality of anchor APs;
generating an initial set of AP positions in a Cartesian coordinate system based on the proximity matrix;
creating a list of possible permutations of user-provided anchor AP coordinates for the plurality of anchor APs;
computing a transformation for each possible permutation in the list of possible permutations;
generating a final set of AP positions from each transformation;
computing a distortion ratio for each final set of AP positions;
determining whether the distortion ratio for the final set of AP positions that correspond to the user-provided anchor AP coordinates is equal to or exceeds a predetermined threshold value; and
displaying on a geo-referenced floor plan that corresponds to the floor, based on whether it is determined that the distortion ratio for the final set of AP positions that correspond to the user-provided anchor AP coordinates is equal to or exceeds the predetermined threshold value, a visual indicator of a corrected placement of the APs, the visual indicator being of the final set of AP positions that has a minimum distortion value.

16. The method of claim 15, wherein computing a distortion ratio for each final set of AP positions comprises:
calculating a difference between the distance between each distinct pair of APs in the proximity matrix and the distance between the same distinct pair of APs in the transformed positions of the final set of AP positions;
obtaining an absolute value of the difference; and
summing the absolute values of the differences of the distinct pairs of the APs of the final set of AP positions to obtain a distortion value for the final set of AP positions.

17. The method of claim 16, wherein computing a distortion ratio for each final set of AP positions further comprises:
identifying the final set of AP positions that has the minimum distortion value; and
obtaining the distortion ratio for the final set of AP positions by dividing the distortion value for the final set of AP positions by the minimum distortion value.

18. The method of claim 17, wherein the predetermined threshold value is between 13 and 17.

19. The method of claim 15, wherein the plurality of anchor APs comprises at least three anchor APs.

20. The method of claim 19, wherein the plurality of anchor APs serve as reference positions for determining locations of other APs on the floor.
